(19) United States
(12) Patent Application Publication
(10) Pub. No.: US 2011/0178995 A1
(43) Pub. Date: Jul. 21, 2011

(54) MICROBLOG SEARCH INTERFACE

(75) Inventors: SEAN SUCHTER, Los Altos Hills, CA (US); RAJESH K. SHENOY, San Jose, CA (US); CHARLES C. CARSON, JR., Cupertino, CA (US); STEVEN WAYNE ICKMAN, Snoqualmie, WA (US); HO JOHN LEE, Palo Alto, CA (US); SHUBHA UMESH NABAR, Palo Alto, CA (US); CLEMENT WANG, Cupertino, CA (US); XIANG JI, Sunnyvale, CA (US); TOM MATTHEW LAIRD-MCCONNELL, Kirkland, WA (US); ERIC R. SCHEEL, Sunnyvale, CA (US)

(73) Assignee: MICROSOFT CORPORATION, Redmond, WA (US)

(21) Appl. No.: 12/691,145

(22) Filed: Jan. 21, 2010

(51) Int. Cl. G06F 3/048; G06F 17/30

(52) U.S. Cl. 707/692; 715/810; 707/780; 707/741; 707/E17.005; 707/E17.109; 707/E17.002; 715/764

(57) ABSTRACT

Methods, systems, and computer-readable media for searching microblog entries. The microblog entries may be generated through a single microblog website or across multiple microblog sites. Upon receiving a search input, a series of microblog entries responsive to the search input may be displayed to the user. The displayed microblog entries may be the most recently generated microblog entries that are responsive to the search input. In another embodiment, the microblog entries returned are a best match to the search criteria, which may be based on a user authority score for a user that drafted a microblog entry and additional characteristics of the microblog entry.

### BACKGROUND

A microblog website allows users to publish microblog entries that may include brief text updates and/or multimedia. The microblog entries may be published to the public or to a selected group. A microblog entry may also contain a link to additional content, such as a website. A microblog website may provide search functionality to allow users to search for microblog entries on a topic that interests them. Microblog aggregation sites and independent search sites may also provide a mechanism for searching through a group of microblog entries.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention relate generally to a method and system for searching microblog entries. The microblog entries may be generated through a single microblog website or across multiple microblog sites. Upon receiving a search input, a series of microblog entries responsive to the search input may be displayed to the user. The displayed microblog entries may be the most recently generated microblog entries that are responsive to the search input. In another embodiment, the microblog entries returned are a best match to the search criteria, which may be based on a user authority score for a user that drafted a microblog entry and additional characteristics of the microblog entry.

In addition to returning microblog entries as search results, embodiments of the present invention may return a list of links found within microblog entries that are responsive to the search input. A link may be responsive to the search input if it is included in a blog entry that is itself responsive to the search input. Additionally, a link may be responsive to the search input if the linked-to content is responsive to the search input. Embodiments of the present invention may provide auto-suggest search topics based on content of microblog entries. Embodiments of the present invention may also perform filtering on the links and microblog entries displayed to prevent duplication of displayed entries.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of an illustrative operating environment suitable for implementing embodiments of the invention;

FIG. 3 is a diagram of a search results page displaying results of a microblog search, in accordance with an embodiment of the present invention;

FIG. 4 is a diagram of an auto-suggest help feature on a search page, in accordance with an embodiment of the present invention;

FIG. 5 is a flow chart showing a method of displaying microblog entries that are responsive to a search input, in accordance with an embodiment of the present invention;

FIG. 6 is a flow chart showing a method of ranking links extracted from microblog entries according to responsiveness to a search input, in accordance with an embodiment of the present invention; and

FIG. 7 is a flow chart showing a method of providing auto suggest search help based on content of microblog entries, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate generally to a method and system for searching microblog entries. The microblog entries may be generated through a single microblog website or across multiple microblog sites. Upon receiving a search input, a series of microblog entries responsive to the search input may be displayed to the user. The displayed microblog entries may be the most recently generated microblog entries that are responsive to the search input. In another embodiment, the microblog entries returned are a best match to the search criteria, which may be based on a user authority score for a user that drafted a microblog entry and additional characteristics of the microblog entry.

In addition to returning microblog entries as search results, embodiments of the present invention may return a list of links found within microblog entries that are responsive to the search input. A link may be responsive to the search input if it is included in a blog entry that is itself responsive to the search input. Additionally, a link may be responsive to the search input if the linked-to content is responsive to the search input.

Embodiments of the present invention may provide auto-suggest search topics based on content of microblog entries.

Embodiments of the present invention may also perform filtering on the links and microblog entries displayed to prevent duplication of displayed entries.

The terms “microblog site” and “microblog entry” are used throughout this description. A microblog site is a website or application that allows users to generate microblog entries. A microblog site also facilitates publication of the microblog entries to other users. The publication may be to the general public or to a designated group of individuals. The individuals may be designated by an author of a microblog entry or be designated by virtue of their decision to receive microblog entries from the author. Examples of microblog sites include Twitter, Tumblr, Plurk, Emote.in, Squeeler, Beeing, and Jaiku. Social networking sites such as Facebook, MySpace, Linkedin, and XING also provide microblog features and may be considered microblog sites in some embodiments of the invention. In one embodiment, the microblog entries may be status updates provided on social networking websites.

A microblog entry may contain text, multimedia, and links to other content. A microblog entry may also contain metadata, like the user's location and language. The microblog entries may be submitted through text messaging, instant messaging, e-mail, through applications on a computer or mobile device, or through an interface on a website. A microblog entry differs from a traditional blog entry primarily in size. A microblog entry may be a sentence, a fragment, a few words, or a brief multimedia, such as a short video. In one embodiment, a short comments on existing content like blogs, videos, or reviews are considered microblog entries.

Accordingly, in one embodiment, one or more computer-readable media having computer-executable instructions embodied for performing a method of displaying microblog entries that are responsive to a search input are provided. The method includes receiving a search input and displaying a first result set including a threshold number of microblog entries that are responsive to the search input. The method also includes displaying a first link result set that includes a threshold number of links that are responsive to the search input. The links are retrieved from a plurality of links included in one or more microblog entries, and wherein an individual link is responsive to the search input when content within an individual microblog entry containing the individual link is responsive to the search input.

In another embodiment, a method of ranking links extracted from microblog entries according to responsiveness to a search input is provided. The method includes receiving a real-time stream of microblog entries that form a collection of microblog entries. The method also includes identifying a plurality of links that are included in at least one microblog entry within the collection. The method further includes determining a linked-to content for each link in the plurality of links. The method includes indexing said each link in the plurality of links. An individual link is indexed according to content in an individual microblog entry containing the individual link and the individual link's linked-to content. The method includes receiving a search input and displaying a result set including a threshold number of links that are responsive to the search input.

In yet another embodiment, one or more computer-readable media having computer-executable instructions embodied for performing a method of providing auto-suggest search help based on content of microblog entries is provided. The method includes receiving a search input that is one or more letters. The method also includes displaying auto-suggest terms starting with the one or more letters, wherein the auto-suggest terms are chosen for display based on terms used in microblog entries. The method further includes receiving a selection of an individual auto-suggest term within the auto-suggest terms. The method also includes displaying one or more microblog entries that are responsive to the individual auto-suggest term.

Having briefly described an overview of embodiments of the invention, an exemplary operating environment suitable for use in implementing embodiments of the invention is described below.

### Exemplary Operating Environment

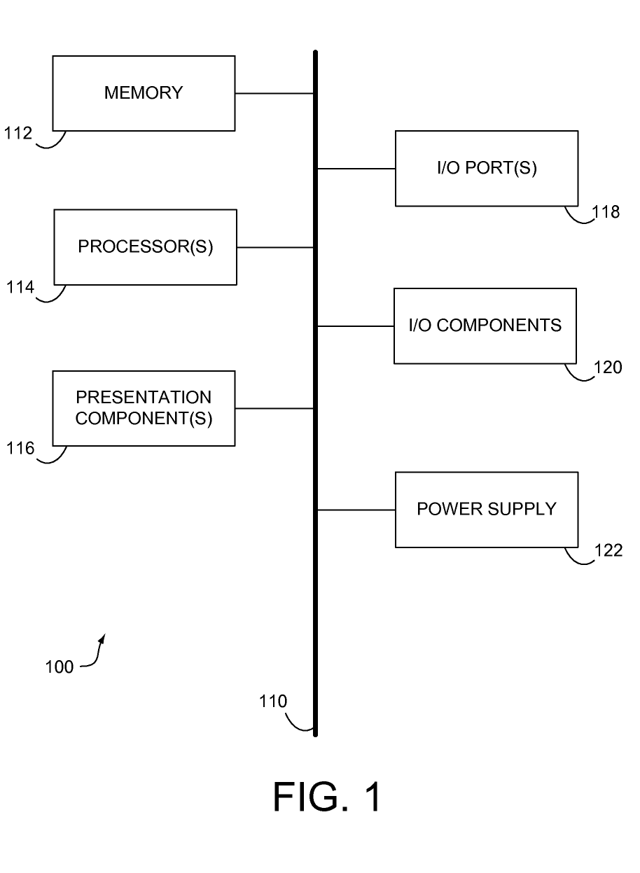

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120t. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-storage media. By way of example, and not limitation, computer-storage media may comprise Random Access Memory (RAM); Read Only Memory (ROM); Electronically Erasable Programmable Read Only Memory (EEPROM); flash memory or other memory technologies; Compact Disk Read-Only Memory (CDROM), digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary System Architecture

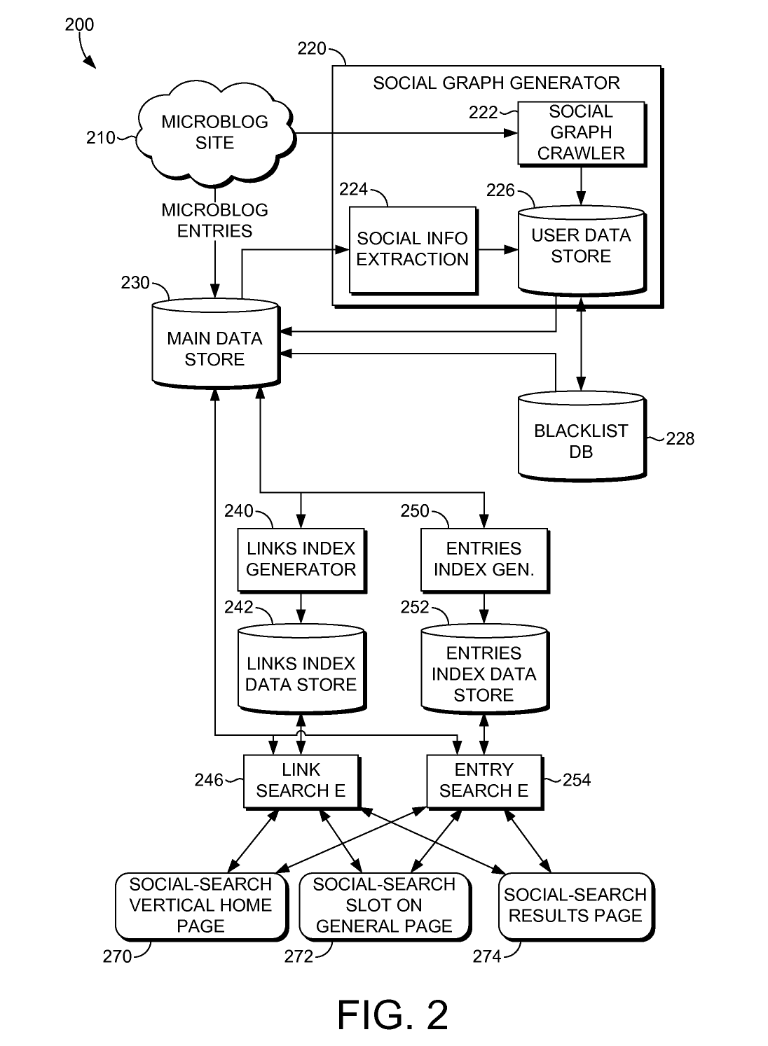

Turning now to FIG. 2, an exemplary operating environment for processing microblog entries and facilitating search of those microblog entries is shown, in accordance with an embodiment of the present invention. The microblog entries and other information associated with users of a microblog site 210 are communicated to a main data store 230 and a social graph generator 220. The microblog entries and additional information may be provided in a real-time stream of data that communicates new microblog entries as they are published on the microblog site 210. The real-time stream may be referred to as a fire hose of data from the microblog site 210. In one embodiment preprocessing of the microblog entries within the fire hose may occur prior to their storage in main data store 230. For example, adult and spam filtering may be used to prevent offending microblog entries from being stored in the main data store 230. Spam, adult, and other filtering may occur other places throughout the processing of microblog entries and display of search results. In addition to spam filtering, an entry's rank may be demoted based on a spam analysis.

The social graph generator 220 includes a social graph crawler 222, a social info extraction component 224, and a user database 226. The social graph generator 220 may perform functions on one or more computing devices similar to computing device 100 described previously with reference to FIG. 1.

The social graph crawler 222 builds a social graph of user relationships within the microblog site 210. A relationship between users may be formed when a first user is following the microblog entries of a second user. In a limited publication microblog site, the users that have permission to view another user's microblog entries may be said to have a relationship with each other. The social graph built by the social graph crawler 222 may include several layers of relationships for a particular user. The layer or degree of relationships may be described as a hierarchy. The first layer includes direct relationships between users. Thus, a first layer of a social graph for user “A” may include all users following user A. A second layer graph may include all of the users following user A's direct followers. A third layer social graph would include user A's direct followers, second level followers, and all of the followers following the second level followers. Using second and third layer social graphs can provide a better measure of a user's overall influence within the microblog site 210. Once built, the social graph may be stored in the user data store 226.

The social info extraction component 224 may extract social information from the collection of microblog entries. For example, the number of microblog entries sent by a particular user during a time period may be ascertained and recorded in the user data store 226. Other information, such as the number of times a particular user's microblog entries are forwarded by other users may also be determined and recorded in user data store 226.

The social graph generator 220 may analyze the social graphs to determine when individual users within the social graph appear to be spam users. A spam user may be generated by a program in order to generate spam microblog entries. Microblog users that are determined to be spam may be blacklisted in blacklist database 228. Subsequently, microblog entries generated by spam users would be excluded from the main data store 230 or otherwise designated as spam microblog entries and not included in search results. In the alternative, a entry associated with a spam user may receive a lower ranking than comparable entries associated with a non-spam user. The blacklist database 228 may also include a list of spam websites, links, or other data identifying information that may be excluded from search results. The blacklist database 228 may be accessed by other components within system 200 in order to utilize the blacklist information.

Embodiments of the present invention return individual microblog entries and links within microblog entries as search results. A hyperlink to a URL is one example of a link that may be returned as a search result. In order to facilitate efficient searching, the links within microblog entries and the microblog entries themselves may be indexed in a reverse look-up index or other index suitable for searching by a search engine. The links index generator 240 generates an index containing information describing the links. Initially, the links index generator 240 may identify microblog entries that contain a link and extract the links from the microblog entries for further processing. The links index generator 240 may then follow each link to its final destination. The final destination is the website or other linked-to content arrived at after one or more redirects are followed. The final destination may be the content directly linked to within the microblog entry. However, it is common for users to utilize a link-shortening service to conserve space within a microblog entry. The shortened links do not link directly to content, but rather redirect a user to an intended content.

The links index generator 240 will then index each link according to linked-to content and content within a microblog entry containing the link. Since multiple microblog entries may contain the same link, an individual link entry in the index may include information from content in multiple microblog entries. Once generated, the links index may be stored in links index data store 242.

The entries index generator 250 generates an index of content within microblog entries. The entries index generator 250 may retrieve microblog entries from data store 230. The entries index generator 250 may combine user information generated by the social graph generator 220 with content entries describing the microblog entries. Once generated, the entries index is stored in entries index data store 252.

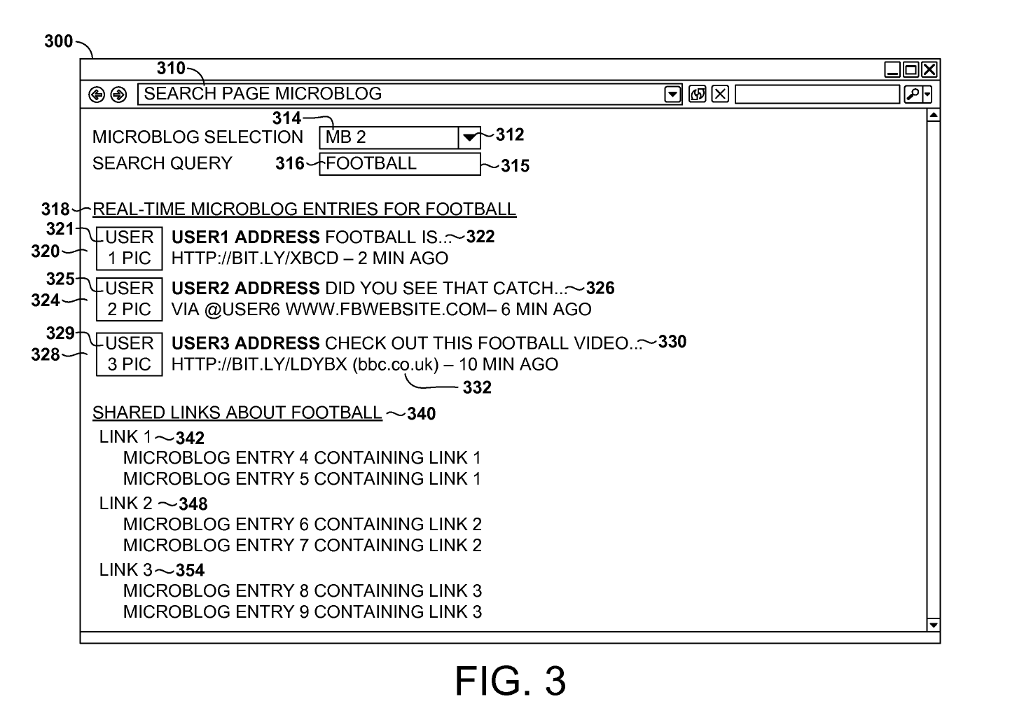

Search input may be received from a user through a search interface. Two such search interfaces are shown in environment 200. The social-search vertical homepage 270 may be a specific search page geared toward searching one or more microblog sites, such as microblog site 210. The general search page 272 may be a search input provided on a search website geared toward a more general category of content. In either case, the results may be presented in a search results page 274. The social-search results page 274 may resemble the results page 300 shown in FIG. 3.

The link search engine 246 finds a set of links that are responsive to the search input using the links index in links index data store 242. The links search engine 246 may select the most recent or best matched links and send them to the social-search results page 274. In one embodiment, a threshold number of links, such as three or ten, are selected. In addition, the link search engine 246 may request microblog entries from the entries index data store 252 that contained the links sent as part of a result set. The social-search results page 274 may display the links in association with one or more microblog entries that contain the links.

The entry search engine 254 retrieves one or more microblog entries that are responsive to the search input. The one or more microblog entries may be selected based on their recent generation or their best match with the search input, or a combination of both. The entry search engine 254 will then send the search results to the social search results page 274 for display.

Turning now to FIG. 3, a search results page 300 displaying results of a microblog search is shown, in accordance with an embodiment of the present invention. The search results page 300 allows a user to provide a search input and displays search results based on that input. The search results page 300 may be displayed in a web browser and accessed by navigating to a URL 310 associated with the search results page 300. Initially a user may select a microblog site to search by toggling through the available microblog sites in the microblog selection input 312. As can be seen, “microblog 2” 314 is selected in the example shown. In one embodiment, a user may select multiple microblog sites to search simultaneously. In another embodiment, the search results page 300 is dedicated to a single microblog site and selection of a particular microblog site to search is not required.

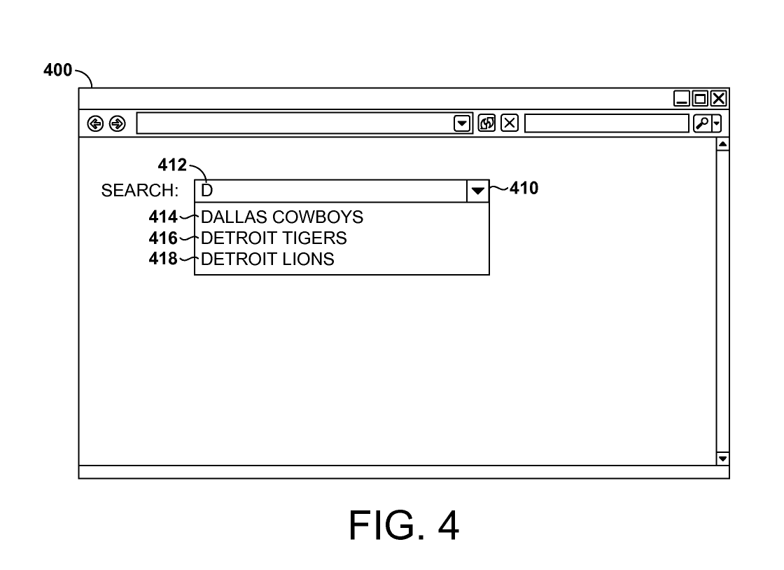

A user may provide a search input in a search input field 315. In this example, the search input 316 is “football.” The search input may be a word, clause, phrase, series of words, or numbers. The search input is not limited to a particular language. In one embodiment, Boolean operators may be used to generate a search input. As shown in FIG. 4, an auto-suggest feature may be utilized in association with the search input field 315.

The search results page 300 shows both microblog entries 318 and links 340 that are responsive to the search input 316. The processes to select responsive microblog entries and links have been described previously and will be explained in additional detail subsequently. Under the microblog entries 318, three separate microblog entries are shown. Microblog entry 320 includes a user picture 321 for the user that generated microblog entry 320. A description 322 of the microblog entry is also included. The description 322 includes user identification information, part of the text of the microblog entry 320, a link within the microblog entry 320, and an indication of the microblog entry's 320 age. In this case, the microblog entry 320 was generated two minutes ago. The microblog entry 324 contains a picture of the user 325 and a description 326. Similarly, the microblog entry 328 includes a picture 329 and a description 330. Microblog entry 328 also includes an annotation 332 indicating the final link when the microblog entry includes a shortened link. This is just one embodiment, and the microblog entry results need not contain user pictures or the description shown in FIG. 3. The link in the description may be a shortened link (as in “BIT.LY/XBCD” within description 226) or an unshortened link (as in fbwebsite.com in 228). Shortened and unshortened links are described in more detail subsequently.

The shared links 340 responsive to the search input 316 include three links. Link 1 342, link 2 348, link 3 354 are shown. Each link is shown with a portion or a summary of a microblog entry containing the link. Link 1 342 is shown with microblog entry 4, which contains link 1 and microblog entry 5, which also contains link 1. In one embodiment, the depiction of the microblog entries underneath the associated link is similar to the ones shown above under the entry results 318. The link 2 is displayed in association with microblog entry 6 containing link 2 and microblog link 7 containing link 2. Link 3 354 is shown with microblog 8 containing link 3 and microblog entry 9 containing link 3 displayed directly below link 3 354.

Turning now to FIG. 4, an auto-suggest interface 400 is shown, in accordance with an embodiment of the present invention. The auto-suggest interface 400 suggests search terms to the user based on receiving a search input. In one embodiment, the suggested search terms are keywords occurring in the content of microblog entries. The keywords selected for display as auto-suggest search terms may be chosen based on their frequency of occurrence within microblog entries. In addition, the immediacy of microblog entries containing the keywords may also be taken into consideration. Thus, frequently and recently used keywords within the content of microblog entries may be displayed to the user as auto-suggest search terms. In FIG. 4, a search box 410 allows the user to submit a search input. In response to the search input, one or more microblog entries that are responsive to the search input may be shown. The display of search results may be similar to search results page 300 described previously with reference to FIG. 3. In the example shown in FIG. 4, a user has inputted the search term “D” 412. In response, three auto-suggest search terms are displayed to the user. The auto-suggest search terms include “Dallas Cowboys” 414, “Detroit Tigers” 416, and “Detroit Lions” 418.

In one embodiment, the auto-suggest search terms are generated based on analysis of content in a real-time stream of microblog entries. The keywords may be extracted from content in the microblog entries. The keywords may be ranked according to the frequency of use. In one embodiment, the keywords are continuously reranked to take into account additional microblog entries using the keyword. In addition, a time-weighting mechanism may be used so that recently used terms are given more weight in the scoring of each keyword. Upon receiving at least one letter in the search input, the highest ranked keywords are displayed to the user as auto-suggest search terms. Again, the source of these keywords is the content of the objects searched. In this case, the objects are a plurality of microblog entries. In one embodiment, the keywords are not selected based on their inclusion in queries. A keywords inclusion in queries may be used to rank the auto-suggest terms so that the terms most likely to be helpful are presented at the top of the list of auto-suggest terms. In one embodiment, auto-suggest terms are drawn from both the content of microblog entries and user queries.

In one embodiment, as additional letters are entered in the search input box, the auto-suggest terms are adjusted to reflect the additional input. For example, if “A” was added after the “D” 412 then the “Detroit Tigers” 416 and the “Detroit Lions” 418 would be removed from the auto-suggest terms. Additional keywords starting with DA, such as the Dalai Lama, would be added to the “Dallas Cowboys” 414.

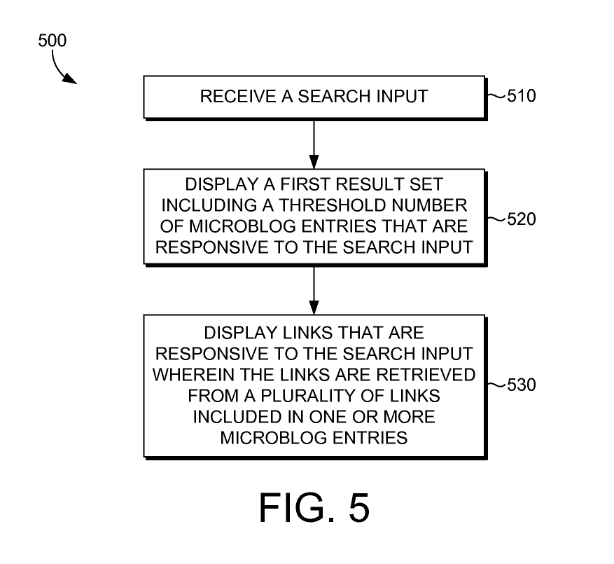

Turning now to FIG. 5, a method 500 of displaying microblog entries that are responsive to a search input is shown, in accordance with an embodiment of the present invention. The method may be performed by a search engine that is accessed by users through an interface displayed on a web page. The method may also be performed by microblog sites and applications that allow users to generate microblog entries. At step 510, a search input is received. The search input may be a single letter, a string of letters and numbers, a word, a clause, a phrase, a sentence, or other similar input. In one embodiment, upon receiving a search input comprising a single letter, auto-suggested search terms are displayed to the user. The user then may select one of the search terms as their search input. As additional letters are added to the search input, the suggested search terms may be updated to match the additional input.

At step 520, a first result set including a threshold number of microblog entries that are responsive to the search input is displayed. In one embodiment, the threshold number of microblog entries is three microblog entries. In one embodiment, a control may be displayed to the user that allows the user to designate the threshold number. The first result set may include the most recent microblog entries that are responsive to the search input. In one embodiment, microblog entries are filtered prior to display. The microblog entries may be filtered for adult content, spam, and other undesirable features. In another embodiment, microblog entries given a lower ranking, rather than completely filtered, if they appear to be spam.

In one embodiment, the first result set is analyzed to prevent displaying essentially duplicate microblog entries. A duplicate microblog entry may occur when a user forwards another microblog entry to other users. As part of the comparison process, the microblog entries may be normalized. The microblog entry may be normalized by removing common forwarding indicators such as are “rt@” and “via@.” The user names, spaces, punctuation, and vowels may also be removed to normalize microblog entries for the sake of comparison. Once normalized, microblog entries are determined to be duplicates if they contain above a threshold amount of duplicate content. For example, a normalized microblog entry that contains 95% of the same content as another microblog entry may be determined to be a duplicate. In such a case, the parent, or older microblog entry may be displayed. The process of identifying duplicate microblog entries may be used regardless of other criteria, such as best match or most recent, used to generate a set of responsive microblog entries.

In another embodiment, the first result set is generated by including microblog entries that are a best match with the search input. A best-match score may be calculated for each microblog entry that is responsive to the search input. A microblog entry may be responsive to the search input if it contains one or more occurrences of the search term within its content. The best-match score for an individual microblog entry may also be based on characteristics of the individual microblog entry and a user that generated the individual microblog entry. Characteristics of the microblog entry include the number of times the individual microblog entry has been forwarded by unique users and length of a microblog entry. In one embodiment, longer microblog entries are favored over short microblog entries. In addition, multiple occurrences of a search input term within an individual microblog entry may increase the best-match score. A user's location (potentially as indicated by metadata associated with their microblog entry), the language of the entry, a spam score for the entry, a spam score of the user generating an entry, the occurrence of query terms in the entry, the occurrence of links in the entry, and the occurrence of words that may indicate a higher or lower quality entry may also be used to generate a best-match score.

Characteristics of the user that may be used include a user-authority score for the user and a spam determination for the user. Programs are available to create users of microblog sites to generate spam entries. Techniques are available to identify these spam users. Once identified, a spam probability score may be assigned to an individual user indicating a probability that the user is a fictitious user generated for the purpose of sending spam. In another embodiment, spam users are blacklisted and microblog entries generated by these users are excluded from display as part of a search result. In either case, generation by a spam user may lower a best-match score for a microblog entry.

The user-authority score may be generated by analyzing a social graph within the relationships established between user accounts in a microblog site. The number of users directly following an individual user may be considered a first degree social graph. Thus a simple way to generate a user score is to total the number of users following an individual user. For example, a user with five followers would have a user-authority score of 5 and a user with 100 followers would have a user-authority score of 100. Different methods of adjusting the user-authority score so that a user with 100 followers is not actually 20 times more authoritative than a user with 5 followers may be used. For example, taking the log of the individual number of followers may be used to generate a user-authority score.

In one embodiment, a second degree social graph is used to calculate a user-authority score. A second degree social graph looks at the number of followers each follower of a user has. For example, a user with 5 followers may have a first follower that in turn has 100 followers, a second follower that has 15 followers, a third follower with 1,000 followers, a fourth follower with 25 followers, and a fifth follower with 1 follower. In one embodiment, the total followers on the user's second degree graph are also included in the user-authority score. Again, embodiments of the present invention are not limited to calculating a user-authority score by adding the number of users from one or more levels of a social graph, but may use other formulas that reflect relative authority based on users following an individual user. For example, a user-authority score may be calculated with a formula that gives more weight to followers on the first level of the social graph than is given to a number of users on a second level of the social graph.

Continuing with reference to FIG. 5, at step 530 a set of links including a threshold number of links that are responsive to the search input are displayed. Each link within the set of links is retrieved from one or more microblog entries within the scope of search. As described previously, the scope of search may be all microblog entries generated through a particular microblog site or may span multiple microblog sites. In step 530, the links are not randomly retrieved from the Internet using a web crawler or other method but are found within a microblog entry. An individual link may be responsive to the search input when content within a microblog entry including the link is responsive to the search input. In another embodiment, a link is responsive to the search input if the linked-to content is responsive to the search input. For example, a link would be responsive to the search input if a linked-to website contained content that was responsive to the search input.

Oftentimes users will include a shortened link specially designed for inclusion within a microblog entry. The specially designed shortened link redirects the user to a different link or URL. For the purpose of this disclosure, shortened links also include HTML frames around unshortend URLs. It is possible for users to provide shorten links to a shortened link, which eventually leads to the final destination URL or linked-to content. Users may shorten already shortened links by mistake or by an intentional attempt to obscure the final destination. Embodiments of the present invention may follow each link through one or more redirects until the final destination is reached. Many different shortened links may point to the same final destination URL. The link displayed in response to the search results at step 530 may be a direct link to the final destination. The displayed link may be the URL for the linked-to content even though an actual direct link to the linked-to content did not occur within any microblog entries falling within the scope of the search. At least an indirect link to the displayed link would need to be included in at least one microblog entry.

In one embodiment, one or more microblog entries containing a link are displayed adjacent to the link. For example, a link within the set of links may be displayed with three microblog entries that linked, either directly, or indirectly to the link directly below the displayed link. Thus, a user may select a link, or select a microblog entry containing the link. In one embodiment, microblog entries are displayed with each link occurring within the set of links.

De-duplication may occur with the links in a similar manner as occurs with the microblog entries. The de-duplication of links is based on the linked-to content or final destination. De-duplication may be based on a shingle print and basic normalization of the URL. Statistics (e.g., user authority score, microblog entry score, occurrence frequency) from de-duped links may be combined to generate a single rank for the link.

The links may be selected for inclusion within the set of links based on a rank assigned to the link. In one embodiment, a link is assigned a rank based on one or more of factors. The factors may be combined and weighted to favor recent links, best-matched links, or any desired combination. The links with the most desirable score may be included in the results.

As stated, many factors, or sub-ranks, may be combined to rank a link. The link may be assigned a frequency rank that increases when the link is included in microblog entries more in more a first period of time as compared to a second period of time. For example, a link occurring more in the past day than in the past month or in the last hour more than the last 24 hours may earn a high frequency rank. A title score based on a number of query terms occurring in title of the linked to document may be included in the overall link rank. The average user authority score for all users that have generated a microblog entry containing the link may be used to rank the link. A language score may be calculated that favors use of a particular language such as English. A link ranking may be reduced based on a link to adult content. A link to a domain or document determined to be spam may reduced a link rank.

A composite entry score may be calculated for each link. The composite entry score is based on an evaluation of parent entries including the link. As described previously, a parent entry is an entry that is forwarded in separate microblog entries. The composite entry score for a link is increased if the link is included in multiple parent entries generated by users with a favorable user authority score. The composite score may be further increased when multiple parent entries each contain a high percentage of query terms. The composite entry score may be decreased if a single parent microblog entry occurs much more than other parent entries containing the link. The composite entry score may also be decreased when multiple parent entries that include the link do not include a high percentage of query terms.

The volume of microblog entries including the same link may also be used to calculate a score for a link. The total unique entries (after identification of duplicates) including the same link may also be used to calculate a best-match score for a link. Other characteristics, such as the popularity of a linked-to website and number of occurrences of the search input on the linked-to website may be used to determine the score for a link.

In one embodiment, a user may request display of additional links or additional microblog entries that are responsive to the search input. Upon receiving a request to display more microblog entries or links, a second set of microblog entries that are responsive to the search input are generated. The second set may include twice the number of microblog entries originally displayed. In addition, the second set may be based on microblog entries received after the first result set was displayed. A second result set may be generated by subtracting all of the microblog entries within the first result set from the second set of results. The process for generating additional links is similar. A set of links with twice the threshold number of links is generated. The set of additional links is all of the new links minus the ones previously displayed. The new set of links may include links within microblog entries received after the search input was originally received. This process may be repeated to generate a third, fourth or fifth set of additional links. In each case, the calculations of the most recent or best matched links are repeated with an additional threshold number of microblog entries included in the calculation. In each case, previously displayed microblog entries are removed from the calculated set to arrive at the set displayed.

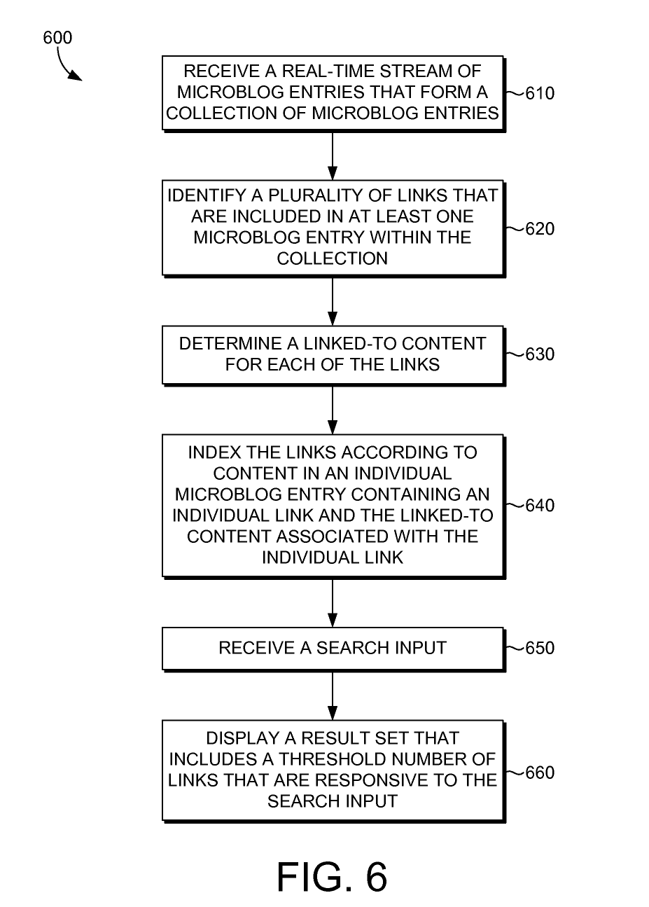

Turning now to FIG. 6, a method 600 of ranking links extracted from microblog entries according to responsiveness to a search input is shown, in accordance with an embodiment of the present invention. At step 610, a real-time stream of microblog entries is received. The real-time stream of microblog entries forms a collection of microblog entries that forms the subject of the search. The real-time stream of microblog entries may be continuously received as new microblog entries are generated.

At step 620, a plurality of links that are included in at least one microblog entry within the collection of microblog entries are identified. Some microblog entries within the collection will include links while others will not. A link may be a hyperlink to a web site or to a link shortener that in turn redirects to a web site or other content.

At step 630, a linked-to content is determined for each of the links. The linked-to content is the web page or other content that is the intended destination of the link. For example, an intended destination, or final destination, would be the destination a user arrives at after clicking the link. The user may be taken through one or more redirects before reaching the intended destination.

At step 640, the links are indexed according to a content in an individual microblog entry containing an individual link and according to the linked-to content associated with the individual link.

At step 650, a search input is received. At step 660, a result set including a threshold number of links that are responsive to the search input is displayed. The links may be responsive to the search input if a linked-to content is responsive to the search input or if content in a microblog entry containing the link is responsive to a search query. In one embodiment, the result set includes links contained in one or more recently generated microblog entries. In another embodiment, the links are selected for inclusion in the result set based on a best-match score assigned to the links. The best-match score may take into account a user-authority score for a user that generated a microblog entry containing the link. Examples of additional information that may also be used to generate a best-match score include: a location of the user that generated the individual microblog entry, a language of the individual microblog entry, a spam score for the individual microblog entry, a quality score for the individual microblog entry, and a spam score for the user that generated the individual microblog entry. The best-match score may be based on a spam score for an microblog entry. The spam scores may be determined by based on a set of signals. These signals include but not limited to an entries' content, an entries' information, a users' information, a users' historical contents, and a users' behaviors. In one embodiment, the links are displayed with one or more microblog entries that contain the links. This may be similar to the search results page 300.

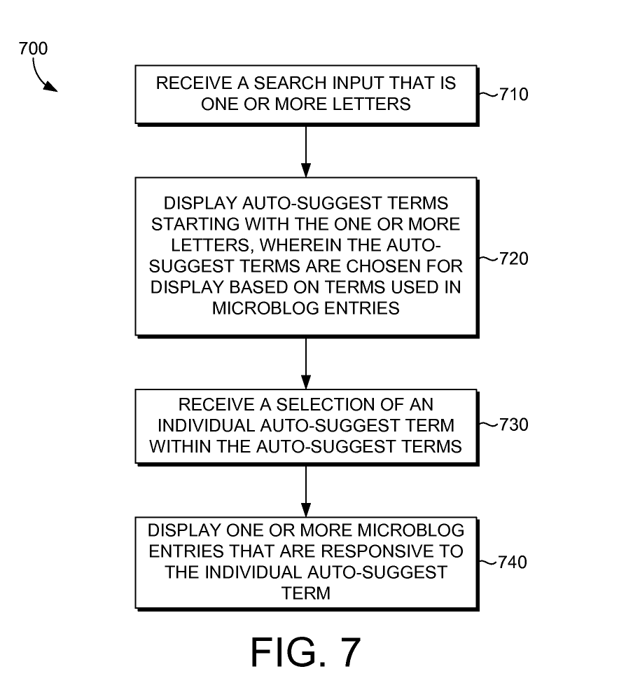

Turning now to FIG. 7, a method 700 of providing auto-suggest search help based on content of microblog entries is shown, in accordance with an embodiment of the present invention. At step 710, a search input that is one or more letters is received. The one or more letters may not form a full word. The interface used may be similar to the search input depicted in FIG. 4.

At step 720, auto-suggest terms starting with the one or more letters are displayed to the user. The auto suggest terms are chosen for display based on terms used in microblog entries. In other words, the scope of auto-suggest terms may be drawn only from the content of microblog entries. In one embodiment, the auto-suggest terms are not chosen based on their use in a search query. The auto-suggest terms may also be ranked based on their frequency of occurrence in microblog entries, without considering whether they occur within user queries. The terms may be ranked for display purposes based on frequency of use in microblog entries and/or queries. Thus, the collection of terms that may be displayed to the user as part of the auto-suggest help are drawn from an analysis of microblog entries. Certain auto-suggest terms may be favored based on their frequency of occurrence in microblog entries.

At step 730, a selection of an individual auto-suggest term is received. At step 740, one or more microblog entries that are responsive to the individual auto-suggest terms are displayed. In addition to microblog entries, links found in microblog entries may also be displayed with the microblog entries.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-readable media having computer-executable instructions embodied thereon for performing a method of displaying microblog entries that are responsive to a search input, the method comprising:
receiving a search input;
displaying a first result set including a threshold number of microblog entries that are responsive to the search input; and
displaying a first link result set that includes a threshold number of links that are responsive to the search input, wherein the links are retrieved from a plurality of links included in one or more microblog entries, and wherein an individual link is responsive to the search input when content within an individual microblog entry containing the individual link is responsive to the search input.

2. The media of claim 1, wherein the method further comprises displaying, adjacent to a link within the first link result set, at least one microblog entry containing the link.

3. The media of claim 1, wherein each microblog entry within the first result set is selected for inclusion based on how recently said each microblog entry was generated.

4. The media of claim 3, wherein the method further comprises performing a de-duplication process on microblog entries that are responsive to the search input to prevent two or more microblog entries with above a threshold amount of duplicate content from being displayed within the first result set.

5. The media of claim 1, wherein each microblog entry within the first result set is selected for inclusion based on a best-match score, wherein the best-match score for an individual microblog entry is calculated using one or more of an user-authority score for a user that generated the individual microblog entry, a location of the user that generated the individual microblog entry, a language of the individual microblog entry, a spam score for the individual microblog entry, a quality score for the individual microblog entry, and a spam score for the user that generated the individual microblog entry.

6. The media of claim 5, wherein the method further comprises performing a de-duplication process on microblog entries that are responsive to the search input to prevent two or more microblog entries with above a threshold amount of duplicate content from being displayed within the first result set.

7. The media of claim 5, wherein the user-authority score for the user is based on a number of users following the user, a user authority score for each of the number of users, and a number of users following the user's followers.

8. The media of claim 1, wherein the method further comprises displaying a second link result set of the threshold number of links, wherein the second link result set is generated by generating a group of links that are responsive to the search input that includes two times the threshold number of links and then removing the links that were previously displayed as part of the first link result set.

9. The media of claim 1, wherein the method further comprises displaying a second result set of the threshold number of microblog entries that includes at least one microblog entry received after the first result set was displayed, wherein the second result set is generated by generating a group of microblog entries that are responsive to the search input that includes two times the threshold number of microblog entries and then removing microblog entries that were previously displayed as part of the first result set.

10. A method of ranking links extracted from microblog entries according to responsiveness to a search input, the method comprising:
receiving a real-time stream of microblog entries that form a collection of microblog entries;
identifying a plurality of links that are included in at least one microblog entry within the collection;
determining a linked-to content for each link in the plurality of links;
indexing said each link in the plurality of links, wherein an individual link is indexed according to content in an individual microblog entry containing the individual link and the individual link's linked-to content;
receiving a search input; and
displaying a result set including a threshold number of links that are responsive to the search input.

11. The method of claim 10, wherein an individual link is responsive to the search input when the individual link's linked-to content is responsive to the search input

12. The method of claim 10, wherein an individual link is responsive to the search input when content within an individual microblog entry containing the individual link is responsive to the search input.

13. The method of claim 10, wherein determining the linked-to content for an individual link is accomplished by following the individual link through one or more redirects.

14. The method of claim 10, further comprising displaying, in association with an individual link within the result set, at least one microblog entry including the individual link.

15. The method of claim 10, wherein an individual link within the result set is selected for inclusion based on a best-match score with the search input that is calculated based on one or more of: a number of times the individual link was been included in microblog entries generated by different users, a user-authority score for a user that generated an individual microblog entry that included the individual link, a location of the user that generated the individual microblog entry that included the individual link, a language of the individual microblog entry that included the individual link, a spam score for the individual microblog entry that included the individual link, a quality score for the individual microblog entry that included the individual link, and a spam score for the user that generated the individual microblog entry that included the individual link.

16. The method of claim 10, wherein an individual link within the result set is selected for inclusion based on a best-match score with the search input that is calculated based on based on a user-authority score for a user that generated a microblog entry containing the individual link, wherein the user-authority score for an individual user is based on a number of users following the individual user and a number of users following the user's followers.

17. One or more computer-readable media having computer-executable instructions embodied thereon for performing a method of providing auto-suggest search help based on content of microblog entries, the method comprising:
receiving a search input that is one or more letters;
displaying auto-suggest terms starting with the one or more letters, wherein the auto-suggest terms are chosen for display based on terms used in microblog entries;
receiving a selection of an individual auto-suggest term within the auto-suggest terms; and
displaying one or more microblog entries that are responsive to the individual auto-suggest term.

18. The media of claim 17, wherein the method further comprises displaying one or more links that are responsive to the individual auto-suggest term, wherein the one or more links are contained in at least one microblog entry.

19. The media of claim 18, wherein the one or more links are selected for display based on a best-match score, wherein the best-match score for an individual link is calculated based on a user-authority score for a user that generated a microblog entry containing the individual link, wherein the user-authority score for the user is based on a number of users following the user and a number of users following the user's followers.

20. The media of claim 17, wherein the method further comprises performing a de-duplication process on microblog entries that are responsive to the search input to prevent two or more microblog entries with above a threshold amount of duplicate content from being displayed within the one or more microblog entries.
